(19) United States
(12) Patent Application Publication
(10) Pub. No.: US 2026/0168655 A1
(43) Pub. Date: Jun. 18, 2026

(54) System for mounting a fixture to a wall

(71) Applicant: Green Creative, LTD, Hong Kong (CN)

(72) Inventors: Taylor Rew, Sanford, FL (US); Calum Scott, Sanford, FL (US); Mark Czajkowski, Sanford, FL (US); Jonathan Hermansen, Sanford, FL (US); Devin Jernigan, Sanford, FL (US)

(73) Assignee: Green Creative, LTD, Hong Kong (CN)

(21) Appl. No.: 18/831,371

(22) Filed: Dec. 18, 2024

(51) Int. Cl. F21V 21/02

(52) U.S. Cl. CPC F21V 21/02

(57) ABSTRACT

A system for mounting a fixture to a wall includes a cover plate for securing to an electrical box, a J-box or any other suitable mounting accessory. The cover plate has a body portion with a lower hanger portion an upper hanger portion for suspending the fixture during installation. The system also includes a securing mechanism for securing the fixture and cover plate together.

### FIELD OF THE INVENTION

This invention relates to a system for mounting fixtures. More specifically, this invention relates a system for mounting a fixture to a wall.

### BACKGROUND OF THE INVENTION

There are a number of systems for mounting fixtures flush to a wall or a ceiling. Most of the available systems include a cover plate or bracket that connect to an electrical box, such as a J-box (junction box). In operation, the cover plate or bracket is attached to the electrical box or J-box. After the cover plate or bracket is attached to the electrical box or J-box, the fixture is wired to electrical connections from the electrical box or J-box and screws or bolts are used to secure the fixture to the cover plate.

### SUMMARY OF THE INVENTION

The present invention is directed to a system for mounting a fixture, such as a light fixture, to a wall. The system includes a cover plate for securing to an electrical box, a J-box or any other suitable mounting accessory. The cover plate comprising a body portion that attaches to the electrical box using any suitable means, such as threaded screws. The cover plate has a lower hanger portion, an upper hanger portion and at least on aperture for feeding and connecting power wires or power connectors to the fixture.

In operation, the cover plate is attached to an electrical box, a J-box or any other suitable mounting accessory. The fixture is then suspended on the lower hanger portion of the cover plate and is connected to the power wires or power connectors. Once the fixture is connected to the power wires or power connectors, the fixture is suspended on the upper hanger portion of the cover plate in an installation position and is secured to the cover plate in the installation position via a securing mechanism.

The securing mechanism can include threaded features that when turned engage and push against the lower hanger portion of the cover plate. This caused the upper hanger portion of the cover plate to engaged and secure to upper bracket that is that is connected to the fixture and, thereby, securing the fixture in the installation position. Other securing mechanisms, such as spring pins, clips and the like are also contemplated. Preferably lower hanger portion of the cover plate includes apertures, slots or depressions for engaging with the threaded features and, thereby, further securing the fixture to the cover plate. The apertures, slots or depressions with the threaded features positioned therein holds the fixture flush with the wall and prevents the fixture from shifting or moving.

In accordance with the embodiments of the invention, the lower hanger portion of the cover plate includes a hanger bracket with a base that connects to a lower lip on the cover plate. The hanger bracket has two hanger tabs that extend upwards when attached to the lower lip of the cover plate to form the lower hanger portion. The upper hanger portion can include a continuous flange tab that extend upwards from the body portion of the cover plate or can include hanger tabs, similar to the lower hanger portion of the cover plate. Preferably, the lower lip on the cover plate includes apertures, slots or depressions for engaging with the threaded features and, thereby, further securing the fixture to the cover plate and flush with the wall and also prevents the fixture from shifting or moving.

### BRIEF DESCRIPTION OF THE DRAWINGS

FIG. 1A shows a schematic representation of a cover plate and an upper bracket for installing a fixture on a wall, in accordance with the embodiments of the invention.

FIG. 1B shows a back-view of a fixture coupled to a system for mounting the fixture to a wall, in accordance with the embodiments of the invention.

FIGS. 2A-B show representations of a system for mounting a fixture to a wall with a securing feature attached to a bottom portion of the fixture, in accordance with the embodiments of the invention.

FIGS. 3A-B show representations of a system for mounting a fixture to a wall with a securing feature attached to a bottom portion of a cover plate, in accordance with an alternative embodiment of the invention.

FIGS. 4A-B show views a cover plate with a lower hanger portion that includes a hanger bracket having a base that connects to a lower lip on the cover plate and that has two hanger tabs that extend upwards, in accordance with the embodiments of the invention.

FIGS. 5A-F show views of a system for flush mounting a fixture to a wall, in accordance with the embodiments of the invention.

FIGS. 6A-B show representations of a fixture that flush mounted to a wall with a J-box using the fixture mounting system of the present invention.

### DETAILED DESCRIPTION OF THE INVENTION

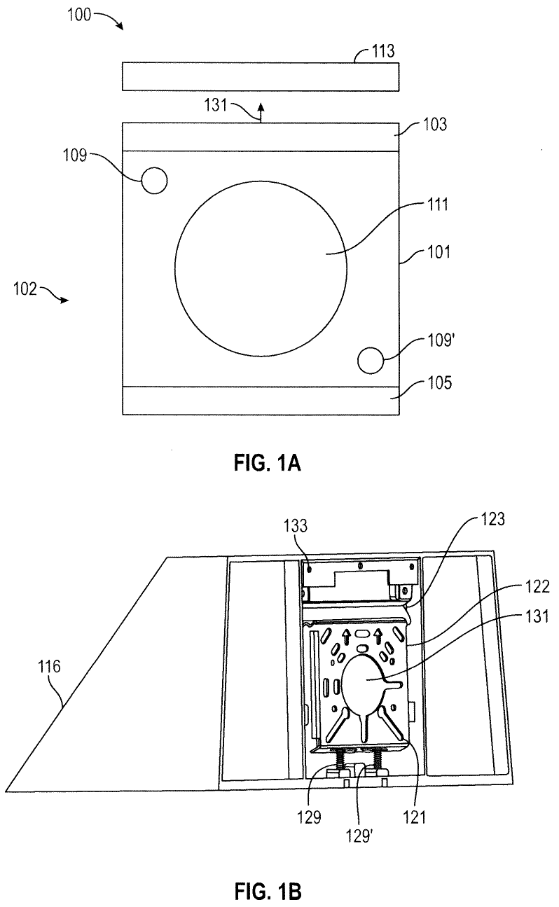

FIG. 1A shows a schematic representation 100 of a cover plate 102 and an upper bracket 113 for installing a fixture on a wall. The cover plate 102 has attachment apertures 109 and 109′ for receiving screws and for securing the cover plate 102 to an electrical box, a J-box or any other suitable mounting accessory. The cover plate 102 has a body portion 101, a lower hanger portion 105, an upper hanger portion 103 and at least on aperture 111 for feeding and connecting power wires or power connectors to the fixture. When the cover plate 102 is moved upwards relative to the upper bracket, as indicated by the arrow 131, the cover plate 102 engages and is secured to the upper bracket 113 which is attached to an upper portion of the fixture.

FIG. 1B shows back-view of a fixture 116 coupled to a system for mounting the fixture 116 to a wall. The system includes a cover plate 122 with lower hanger portion 121 an upper hanger portion 123 and at least on aperture 131, such as described above. The system also has a securing mechanism that includes threaded structures 129 and 129′ that are turned to engage the lower hanger portion 121 of the cover plate 122 and pushes the fixture 116 downward to engage and secure the cover plate 122 with an upper bracket 133 that is attached to and upper portion of the fixture 116 and, thereby, secure the fixture 116 to the cover plate 122 together.

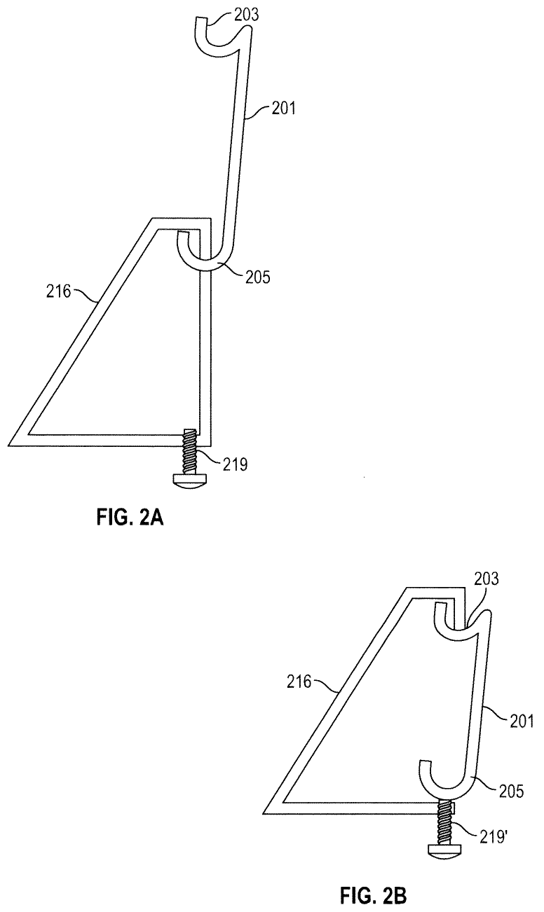

FIGS. 2A-B show representations of a system for mounting a fixture 216 to a wall with a securing feature 219 attached to a bottom portion of the fixture 216. As described above, a cover plate 201 is attached to an electrical box, a J-box or any other suitable mounting accessory. The cover plate 201 has an lower hanger portion 205 and an upper hanger portion 203. The fixture 216 is suspended on the lower hanger portion 205 of the cover plate 201, as shown in FIG. 2A and the fixture 216 is connected to the power wires or power connectors. Once the fixture 216 is connected to the power wires or power connectors, the fixture 216 is suspended on the upper hanger portion 203 in an installation position, as shown in FIG. 2B, and the fixture 216 is secured to the cover plate in the installation position by turning a threaded securing structure 219 on a bottom portion of the fixture 216, thereby urging the upper hanger portion 203 to securely engage with a top portion of the fixture 216, that can an upper bracket 133 (FIG. 1B), such a previously described.

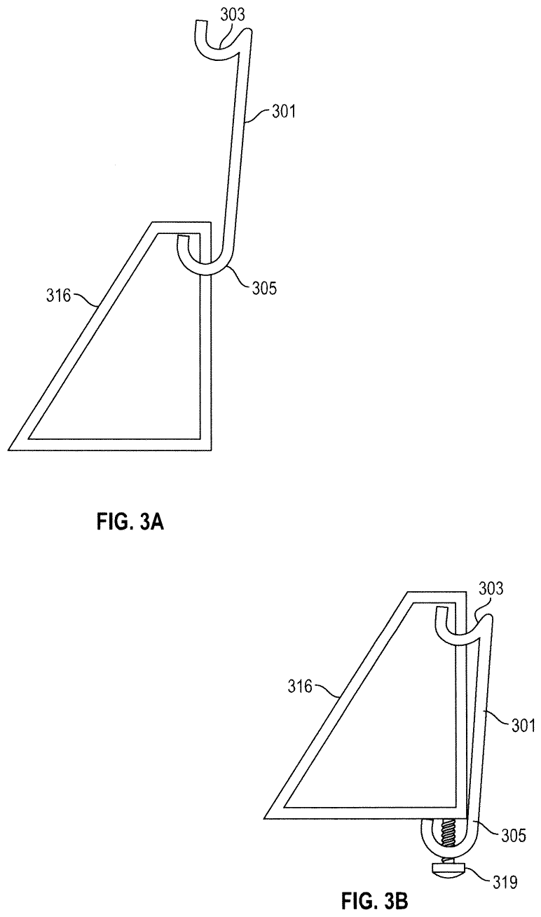

FIGS. 3A-B show representations of a system for mounting a fixture 316 to a wall with a securing feature 319 attached to a lower hanger portion 305 of a cover plate 301, in accordance with an alternative embodiment of the invention. As described above, the cover plate 301 is attached to an electrical box, a J-box or any other suitable mounting accessory. The cover plate 301 has an lower hanger portion 305 and an upper hanger portion 303. The fixture 316 is suspended on the lower hanger portion 305 of the cover plate 301, as shown in FIG. 3A, and the fixture 316 is connected to the power wires or power connectors. Once the fixture 316 is connected to the power wires or power connectors, the fixture 316 is suspended on the upper hanger portion 303 in an installation position, as shown in FIG. 3B, and the fixture 316 is secured to the cover plate in the installation position by turning a threaded securing structure 319 on a bottom hanger portion 305 of the cover plate, thereby urging the fixture 316 securely engage with a top hanger portion 303 of cover plate with a top portion of the fixture 316, that can an upper bracket 133 (FIG. 1B), such a previously described.

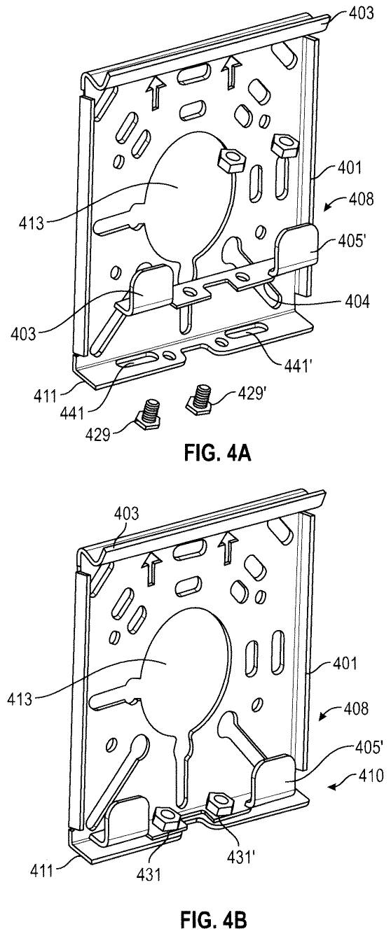

FIGS. 4A-B show a cover plate 401 with a lower hanger portion 410 that includes a hanger bracket 408 with a base 404 that connects to a lower lip 411 on the cover plate 401. The hanger bracket 408 has two hanger tabs 405 and 405′ that extend upwards when attached to the lower lip 411 of the cover plate 401 to form the lower hanger portion 410. The hanger bracket 408 connects to the lower lip 411 of the cover plate 401 through, for example nuts 431/431′ and bolts 429/429′. However, it will be clear to one skilled in the art that the hanger bracket 408 can be attached to the lower lip 411 on the cover plate 401 by any suitable means including, but not limited to, pressure fitted grommets, clips and screws. Preferably, the lower lip 411 on the cover plate 401 includes apertures, slots or depressions 441 and 441′. In operation the threaded features are turned to engage or fit into the apertures, slots or depressions 441 and 441′ to secure a fixture to the cover plate 401, such as described below.

The cover plate 401 also includes one more wire apertures 413 and an upper hanger portion 403. The upper hanger portions 403 can be a continuous flange tab that extend upwards from a body portion of the cover plate 401 or can have multiple hanger tabs. In operation the cover plate 401 is attached to an electrical box and is used to install a fixture to a wall, such as described in detail above.

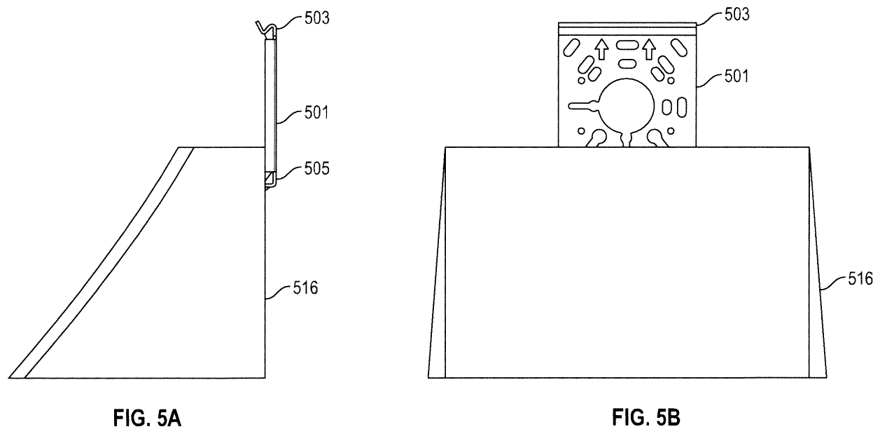

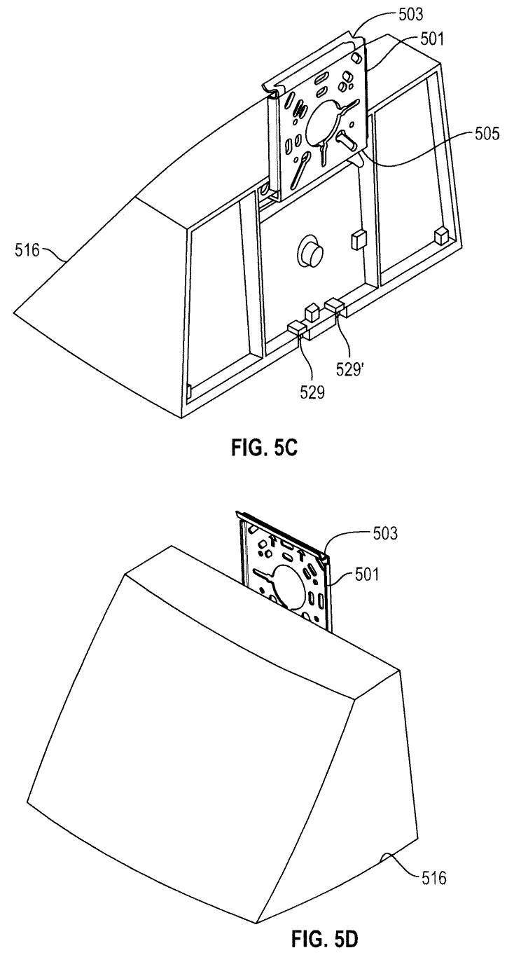

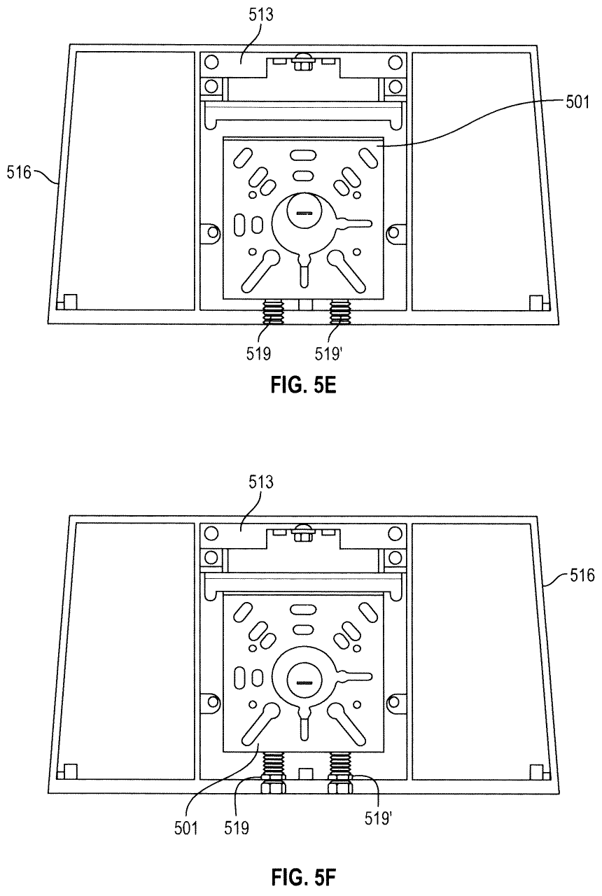

FIGS. 5A-F show system for flush mounting a fixture 516 to a wall. The system includes a cover plate 501, such as the cover plate 401 described with reference to FIGS. 4A-B and an upper bracket 513 attached to the fixture 516. In operation the fixture 516 is placed on a lower hanging portion 505 of the cover plate 501 (FIGS. 5A-D), that includes a hanger bracket 408 with two hanger tabs 406 and 406′ that extend upwards when attached to the lower lip 405 of the cover plate 501. The fixture 516 is then wired for power and the fixture is placed on the upper hanger portion 503 of the cover plate 501 to suspend the fixture 516 in an installation position (FIG. 5E). With the fixture 516 in the installation position, threaded features 519 and 519′ are turned to engage the lower hanger portion 505 of the cover plate 501 urging the fixture 516 downward to secure the fixture 516 to the cover plate 501 and the fixture 516 together in the installation position via the upper bracket 513 attached to the fixture 516. Preferably, the threaded features 519 and 519′ are turned and engage or fit into apertures, slots or depressions 441 and 441′ FIG. 4) on the lower hanger portion 505 of the cover plate 501.

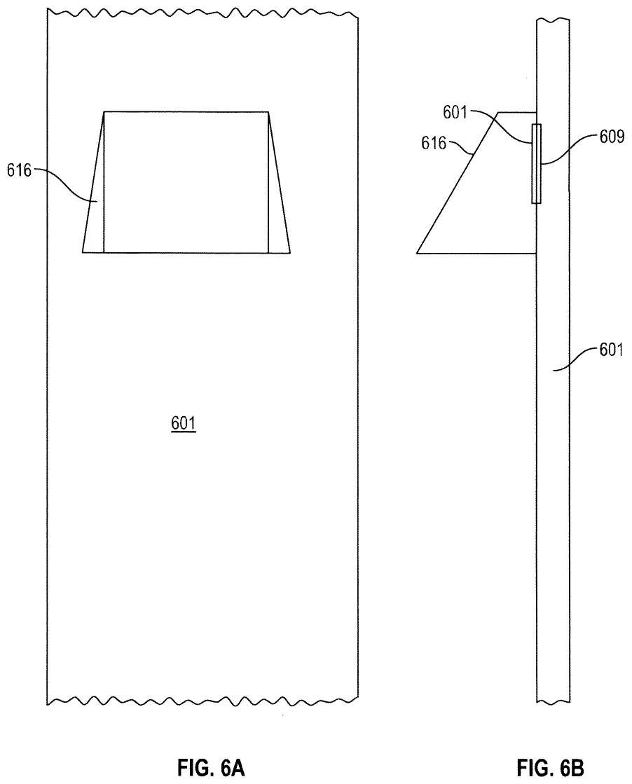

FIGS. 6A-B shows a representation of a fixture 616 that flush mounted to a wall 601 through a J-box 609 using the fixture mounting system of the present invention, that includes a cover plate 601, such as described with reference to FIGS. 4A-B and an upper bracket upper bracket 513 (FIGS. 5E-F) attached to the fixture 616.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1) A system for mounting a fixture to a wall comprising:
a) a cover plate for securing to an electrical box, a J-box or a mounting accessory, the cover plate comprising a body portion with a lower hanger portion for suspending the fixture during installation, a wire aperture for threading power wires to the fixture while the fixture is suspended from the lower hanger portion and an upper hanger portion for suspending the fixture to the cover plate in an installed position; and
b) a mechanism for securing the fixture in the installation position.

2) The system of claim 1, wherein the mechanism includes threaded features that engage the lower hanger portion of the cover plate and when turned secure the upper hanger portion of the cover plate to an upper bracket that is that is connected to the fixture, thereby securing the fixture in the installation position.

3) The system of claim 1, wherein the lower hanger portion includes a hanger bracket with a base that connects to a lower lip on the cover plate and that has two hanger tabs that extend upwards when attached to the lower lip to form the lower hanger portion.

4) The system of claim 1, where that upper hanger portion includes a continuous flange tab that extend upwards from the body portion of the cover plate.

5) The system of claim 1, wherein the fixture is a light fixture.

6) A system for mounting a light fixture to a wall comprising:
a) a cover plate for securing to an electrical box, a J-box or any other suitable mounting accessory, the cover plate comprising a body portion with a lower hanger portion for suspending the fixture during installation, a wire aperture for threading power wires to the fixture while the fixture is suspended from the lower hanger portion and an upper hanger portion for suspending the fixture to the cover plate in an installed position; and
b) a mechanism for securing the fixture in the installation position including threaded features that engage the lower hanger portion of the cover plate and when turned secure the upper hanger portion to an upper bracket of the light fixture, thereby securing the fixture in the installation position.

7) The system of claim 6, wherein the lower hanger portion includes a hanger bracket with a base that connects to a lower lip on the cover plate and that has two hanger tabs that extend upwards when attached to the lower lip and wherein the lower lip includes apertures, slots or depressions that the threaded features fit into when the threaded features are turned.

8) The system of claim 6, where that upper hanger portion includes a continuous flange tab that extend upwards from the body portion of the cover plate.

9) A system for mounting a fixture to a wall comprising:
a) a cover plate for securing to an electrical box, a J-box or any other suitable mounting accessory, the cover plate comprising a body portion with a lower hanger portion that includes a hanger bracket with a base that connects to a lower lip on the cover plate and that has two hanger tabs that extend upwards when attached to the lower lip for suspending the fixture during installation, a wire aperture for threading power wires to the fixture while the fixture is suspended from the lower hanger portion and an upper hanger portion for suspending the fixture to the cover plate in an installed position; and
b) a mechanism for securing the fixture in the installation position.

10) The system of claim 9, wherein the mechanism includes threaded features that engage with or fit into apertures, slots or depressions on the lower hanger portion of the cover plate and when turned secure the upper hanger portion of the cover plate to an upper bracket that is that is connected to the fixture, thereby securing the fixture in the installation position.

11) The system of claim 9, where that upper hanger portion includes a continuous flange tab that extend upwards from the body portion of the cover plate.

12) The system of claim 9, wherein the fixture is a light fixture.
